(19) United States
(12) Patent Application Publication
(10) Pub. No.: US 2009/0226046 A1
(43) Pub. Date: Sep. 10, 2009

(54) Characterizing Or Recommending A Program

(76) Inventor: Yevgeniy Eugene Shteyn, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/247,904

(22) Filed: Oct. 8, 2008

Related U.S. Application Data
(60) Provisional application No. 61/034,803, filed on Mar. 7, 2008.

(51) Int. Cl. G06K 9/00; G06F 17/00; G06F 7/06

(52) U.S. Cl. 382/118; 707/100; 707/3; 707/E17.123

(57) ABSTRACT

A method of characterizing a program includes defining a scene as a portrayal of an emotion of a first character and identifying each scene within a first program to apportion the first program into a series of scenes. An emotional profile of the first program is built according to the series of scenes. Recommendation of a program includes correlating the emotional profile of the first program with a user preference profile.

### BACKGROUND

Nearly everyone has faced the struggle of trying to select a good movie. Unfortunately, the conventional manner of classifying movies by genre is not very informative as to full complexity of the movie. For examples, movies placed within a single genre, such as action, can vary tremendously in their pace, subject matter, and whether the movie is serious or lighthearted. If one has an abundance of time, one can attempt to survey reviews of a movie. However, trusting a review of a movie is questionable because of the varying tastes among the reviewers, which may or may not match your own tastes.

With the advent of the Internet, IPTV, services such as NetFlix®, and the mass production and distribution of DVDs, there is an even wider selection of programs from which to choose. In addition to movies, available programs include TV shows, sports events, educational programs, and so on. However, even with this expanded volume of available programs, classification by genre still dominates the selection process.

Accordingly, consumers and content distributors are left with crude tools for handling an ever increasing supply of content.

### BRIEF DESCRIPTION OF THE DRAWINGS

FIG. 1 is diagram illustrating a method of characterizing a program, according to one embodiment of the present disclosure.

FIG. 2 is a graph illustrating an emotional profile of a program, according to one embodiment of the present disclosure.

FIG. 3 is a chart representing a series of scenes of a program, according to one embodiment of the present disclosure.

FIG. 4 is a diagram illustrating a scene index, according to one embodiment of the present disclosure.

FIG. 5 is a block diagram illustrating a system for recommending and accessing a program, according to one embodiment of the present disclosure.

FIG. 6 is block diagram of a user interface of a program recommendation system, according to one embodiment of the present disclosure.

FIG. 7 is a block diagram of a manager of a program characterization and recommendation system, according to one embodiment of the present disclosure.

FIG. 8 is diagram illustrating a rule set for a series of scenes of a program, according to one embodiment of the present disclosure.

FIG. 9 is a diagram of a resource description of a scene of a program, according to one embodiment of the present disclosure.

FIG. 10 is a flow diagram of a method of characterizing a program, according to one embodiment of the present disclosure.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

Embodiments of the present disclosure relate to a method and system for characterizing and/or recommending a program, such as a movie. In one embodiment, a program is characterized according to an emotional state of one or more characters throughout the program. In one aspect, the program is apportioned into a sequence of scenes in which each scene is defined by a change in the emotional state of a character. After defining or differentiating the scenes of the program, an emotional profile of the program is built on a scene-by-scene basis.

In another aspect, the emotional state of the character remains the same throughout the scene but a physical transition or change in the settings is made, thereby differentiating that scene from other scenes. In another aspect, while in some instances the emotional state of a character does not change, a scene is identified as a separate scene because other aspects (e.g., soundtrack, physical settings, etc.) evoke an emotional response in the viewer.

In a yet another embodiment, a scene is defined (and differentiated from other scenes) as a part of a script between two consecutive Scene Headings which includes at least two elements: (1) an exterior or interior indicator; and (2) a location or setting. In one aspect, the scene is further defined by a time of the day in the story of the program.

A program is recommended to a user based on comparing a user preference profile and the emotional profile of the program(s) to determine a correlation between the user preference profile and the emotional profile of the program(s). In one aspect, the user preference profile comprises one or more parameters relating to the emotional preferences of the user. By using this correlation, a highly accurate recommendation of a program is made to the user.

Moreover, because this method characterizes programs on a scene-by-scene basis, the method makes it practical for the user to become aware of many programs the user would not otherwise consider viewing. For example, in the long tail phenomenon associated with digital media, there are many programs available for viewing but that are generally unknown to a viewer. With the method and system of the present disclosure, programs within the long tail of the universe of digital content can be characterized emotionally and then automatically compared with a user preference profile to produce a list of recommended programs that would have otherwise been unknown to the user. This strategy benefits both the user and owners of programs falling within the long tail of digital content.

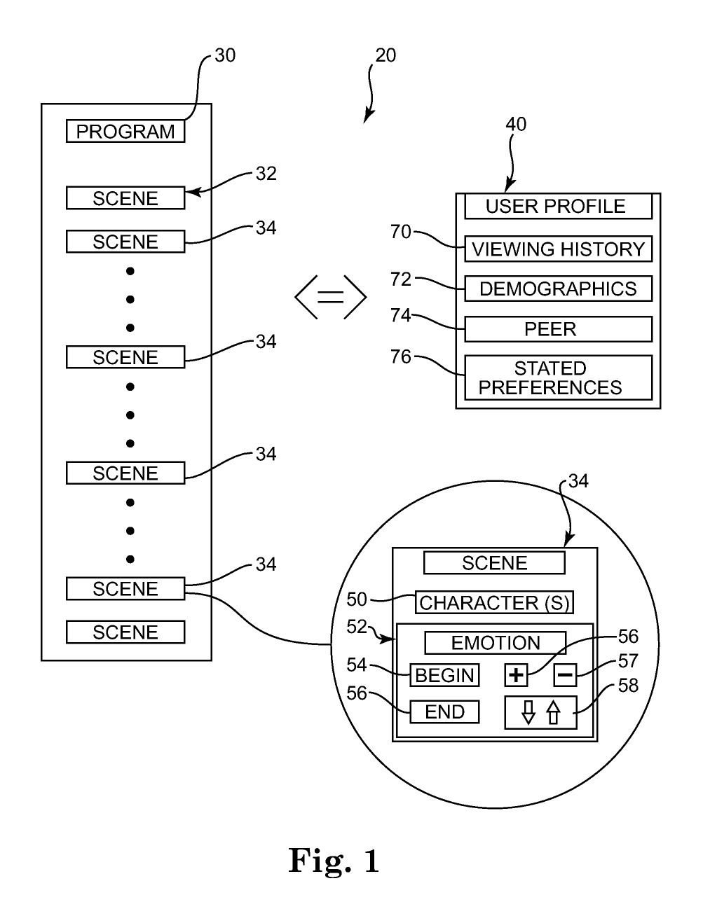

These embodiments, as well as others, are described and illustrated in association with FIGS. 1-10.

A method 20 of characterizing and/or recommending a program 30 to a user is illustrated in FIG. 1, according to one embodiment of the present disclosure. In method 20, a program 30 comprises a series 32 of scenes 34 and user profile 40 provides information about the tastes and habits of the user. Moreover, while one program 30 is shown for illustrative clarity, program 30 represents just one program 30 of a universe of programs that could be recommended to a user. In one aspect, the program 30 comprises any one of a movie, TV show, video, sports event, or other program. In another aspect, each scene 34 comprises one or more characters 50 that display an emotion 52.

One scene 34 is differentiated from other scenes 34 of program 30 in that each scene 34 includes a display of a different emotion of the character or a display of a change from one emotion to another emotion for that character. Accordingly, each scene 34 includes a beginning emotion 54 and an ending emotion 56.

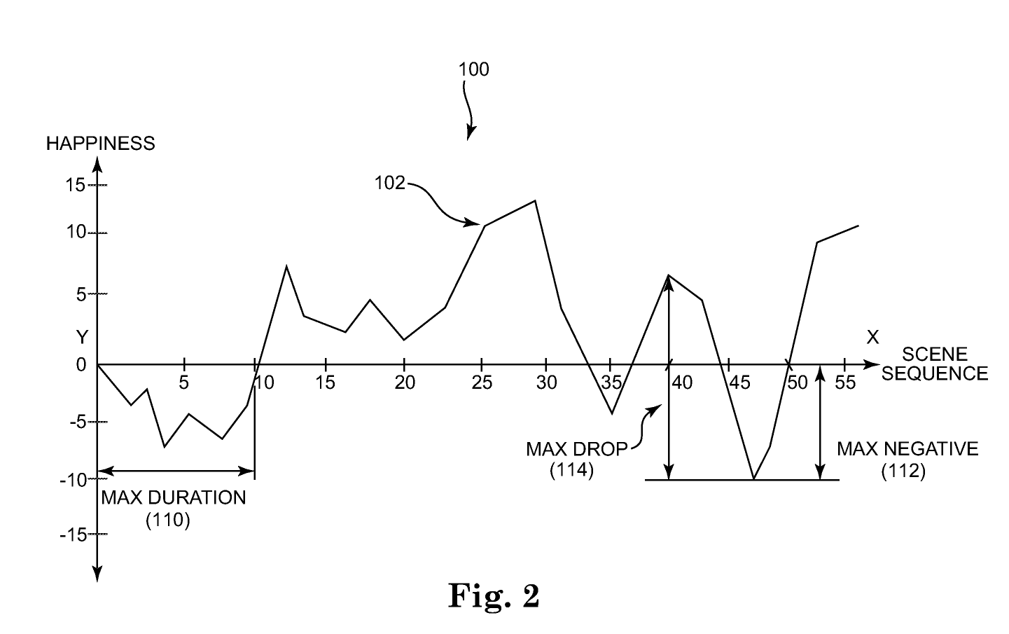

In another aspect, even though some scenes 34 maintain the same emotion for a character, they are defined as a separate scene 34 because of a noticeable increase or decrease (represented by up and down arrows 58) in that emotion. In another non-limiting example, scenes 34 are differentiated from each other based on whether the emotion is a positive emotion 56 (e.g., happiness) or a negative emotion 57 (e.g., sadness). Many other aspects of defining a scene 34 and differentiating one scene 34 from another are described further in association with FIGS. 2-10.

Because each scene 34 is defined based on the emotional display for one or more characters, the scene 34 is not defined by its duration. Moreover, each scene 34 is not necessarily defined by the number of, or type of camera shots, as some scenes 34 include a character maintaining the same emotional state through series of shots.

In another aspect, the program 30 comprises a sports event and scenes 34 are differentiated from each other based on separate plays (e.g., first down play in football, each pitched ball in baseball, etc.) within the sports event. In one embodiment, each play is tagged with an emotional indicator that represents the type and intensity of emotion displayed by one or more players or the type and intensity of emotion evoked in the viewer or announcer based upon the respective play.

In another aspect, an emotional index or other indicator is provided for each scene 34 to represent the emotional nature of the respective scene 34. When considered in sequence, this series of scenes 34 provides an emotional profile of the program 30. Using this tool, each program 30 in the universe of programs is evaluated to build an emotional profile, scene-by-scene, for that program 30. The emotional profile of each respective program 30, in turn, is used to recommend a program 30 (from the universe of programs) to the user by identifying which programs best match the tastes and habits of the user as provided via user profile 40.

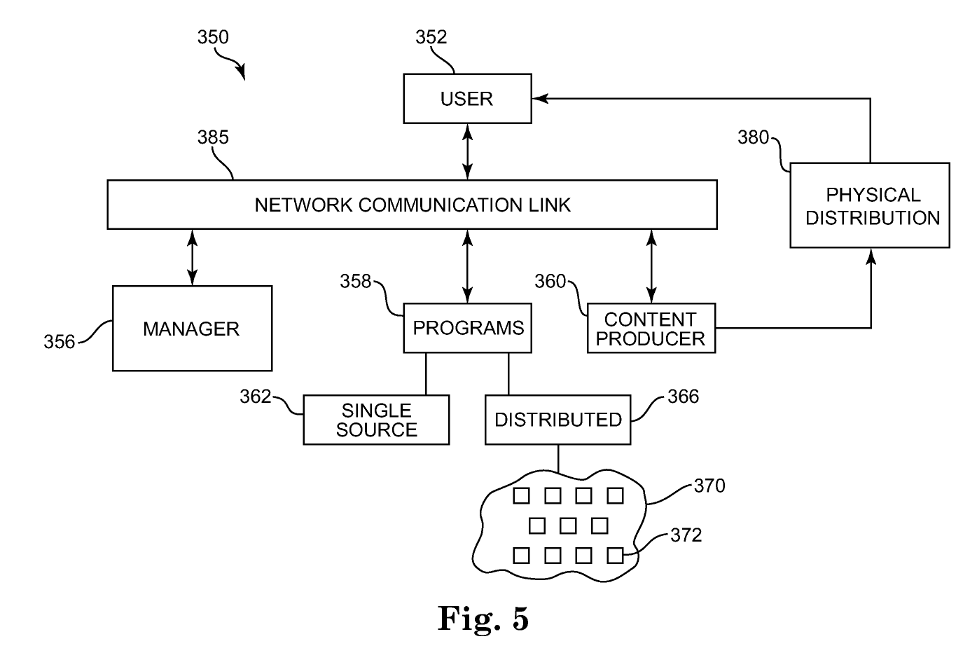

Accordingly, in order to recommend a suitable program 30 to a user, information is obtained about the user and maintained via user profile 40. In one embodiment, user profile 40 comprises viewing history parameter 70, demographics parameter 72, peer parameter 74, and stated preferences parameter 76. In one aspect, viewing history parameter 70 maintains a history of the programs 30 viewed by the user. This history is automatically tracked via a user interface of a viewing device owned or operated by the user, as described later in association with FIGS. 5-7. In addition, the user or the content provider, such as NetFlix®, is capable of logging entries into the history to identify programs 30 that were viewed prior to the start of automatic tracking or that were viewed in venues not associated with the automatic tracking mechanism. In this manner, viewing history parameter 70 enables maintaining a comprehensive history of programs 30 viewed by the user.

In addition to simply providing a history of viewing, this information is used as one factor in identifying other programs 30 that might be of interest to the user. In particular, one can see which types of movies (e.g., genre) that a user tends to watch with some frequency. Moreover, with method 20, the emotional profile of the programs 30 previously viewed by the user is compared with the universe of programs to determine which other programs 30 may be of interest to the user. In one embodiment, method 20 includes identifying other programs 30 (not yet viewed by the user) that include emotional profiles similar to the emotional profile of programs 30 previously viewed by the user, and then recommending those identified programs 30.

The demographics parameter 72 of user profile 40 enables tracking of demographic information about the user, such as their age, gender, ethnicity, religious affiliation (if any), etc. In one embodiment, the demographics parameter 72 is used to identify programs 30 that have an emotional profile known to be attractive to the one of the many different demographic groups within society.

The peer parameter 72 of user profile 40 enables tracking the viewing history, preferences, etc. of one or more peers of the user. In one aspect, the user defines or lists their peers (e.g., friends, family, etc.) and a manager (FIGS. 5-7) tracks the viewing history of those peers in order to access user profile information for those peers to facilitate in recommending a program or movie for the user.

The stated preferences parameter 76 of user profile 40 enables the user to explicitly identify their preferences. For example, a user specifies a preference, non-preference, or dislike for which type of emotion, the intensity of emotions, or the frequency of emotion changes within a program 30. This aspect is described in more detail in association with FIGS. 5-7.

Finally, the user profile 40 is not exclusively limited to the viewing history parameter 70, the demographics parameter 72, the peer parameter 74, and the stated preferences parameter 76.

Using the information about the user tracked via these parameters 70-76 of user profile 40, method 20 compares the emotional profile of each program 30 of the universe of programs with the user profile 40 to identify programs 30 that correlate well with the user profile 40 and that are likely to be enjoyed by the user. By employing a scene-based emotional profile of each program 30 in recommending a program 30, method 20 avoids the conventionally crude technique of choosing programs 30 solely according to genre, age, or other low level information.

FIG. 2 is a graph 100 illustrating an emotional profile 102 of a character in a program according to one emotion, such as happiness (represented along the vertical y axis), according to one embodiment of the present disclosure. Accordingly, the happiness of the character (a positive emotion) is illustrated by portions of the profile 102 extending above the zero mark of the y-axis. Conversely, the unhappiness of the character (a negative emotion, such as sadness, anger, etc.) is illustrated by portions of the profile 102 extending below the zero mark of the y-axis. The sequence of scenes of the program is represented by the horizontal x-axis of the graph so that profile 102 reveals the relative happiness of the character on a scene-by-scene basis throughout the program.

In one example, the character comprises a protagonist of the program. However, emotional profiles are also developed for other characters of the program, such as other protagonists, antagonists, or neutral characters.

After plotting the emotional profile 102 illustrated in FIG. 2, additional aspects of the emotional profile 102 are identified to help characterize the program. In one example, a maximum duration 110 of a negative emotion (e.g., unhappiness) is identified in the early scenes of the program. In another aspect, a maximum negative emotion 112 is identified, as some users would prefer to avoid portrayals of deep unhappiness. On the other hand, some users might prefer large swings of emotion in their programs. Accordingly, a maximum drop 114 is identified in emotional profile 102, which represents a swing from a significantly positive emotion to a significantly negative emotion. While not explicitly labeled, the emotional profile 102 also could exhibit the converse situation of a maximum rise from a significantly negative emotion to a significantly positive emotion. Finally, one can recognize other simple patterns or more complex patterns to facilitate characterizing the emotional profile 102 of the program and then use those recognizable patterns for comparing the program relative to the user profile 40 (FIG. 1) in making recommendations to the user regarding that program or other programs.

Accordingly, in just one example, if a user's stated preferences include a happy ending, one aspect of a method of recommending a program includes identifying programs having a scene-based emotional profile in which a significant duration of positive emotion is portrayed in the scenes at or near the end of the program.

In another embodiment, more than one emotional profile is tracked for a program. For example, the emotional profile of a second character based on the same emotion is developed. Moreover, in yet another embodiment, emotional profiles of other emotions of those same characters are developed and used for comparison with the user preference profile 40.

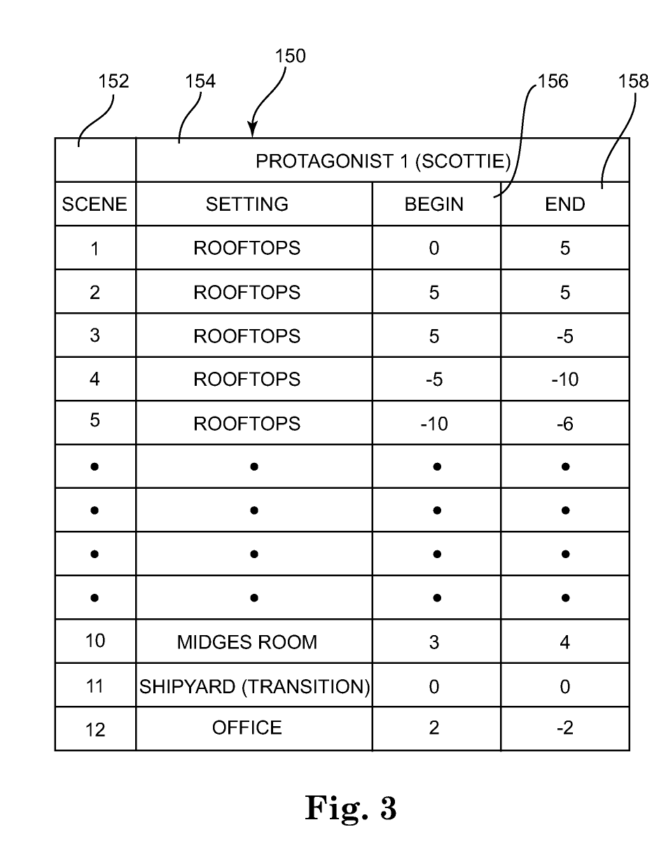

FIG. 3 is a chart 150 illustrating a scene-by-scene characterization of one emotion of a character, according to one embodiment of the present disclosure. The chart represents the data supporting a graphically-represented emotional profile, such as profile 102 of FIG. 2. As illustrated in FIG. 3, chart 150 includes a scene column 152, a settings column 154, a beginning intensity 156, and an ending intensity 158. The scene column 152 identifies the different scenes of the program by a sequential alphanumeric identifier. The settings column 154 identifies an aspect of a scene, such as a location (e.g. rooftop, office, shipyard) in which the scene takes place. The beginning intensity 156 identifies an intensity of the tracked emotion at the beginning of the scene while the ending intensity 158 identifies an intensity of the tracked emotion at the end of the scene. Accordingly, chart 150 illustrates the change in emotional intensity that provides the basis to differentiate one scene from another. For example, scene one is characterized by the emotional intensity changing from zero to five, while scene three is characterized by the intensity changing from five to negative five. On the other hand, scenes two and eleven represent a scene in which the emotional intensity remains level throughout the scene but wherein the segment of the program is defined as a scene because of a change in setting that provides a physical transition for the tracked character or because of some other reason. For example, while there is no change in emotional intensity in scene eleven (zero to zero), the setting of shipyard provides a transition from scene ten (e.g., Midge's room) to scene twelve (e.g., office) and there is a change in emotional intensity from scene ten to scene eleven (e.g., four to zero) and then again from scene eleven to scene twelve (e.g., zero to two).

In one aspect, one can use these numerical indications of emotional intensity for sorting emotional profiles. For example, to provide a recommendation of a mild program, one could apply a filter to exclude programs having negative or positive intensities above four points. Alternatively, one can edit a program according to an emotional intensity preference by excluding all scenes having intensity levels above a desired number, such as five. In one embodiment, a substitute scene is available for replacement of the excluded scene or the scenes are originally made so that a relatively smooth transition takes place between the remaining scenes after excluding one or more scenes.

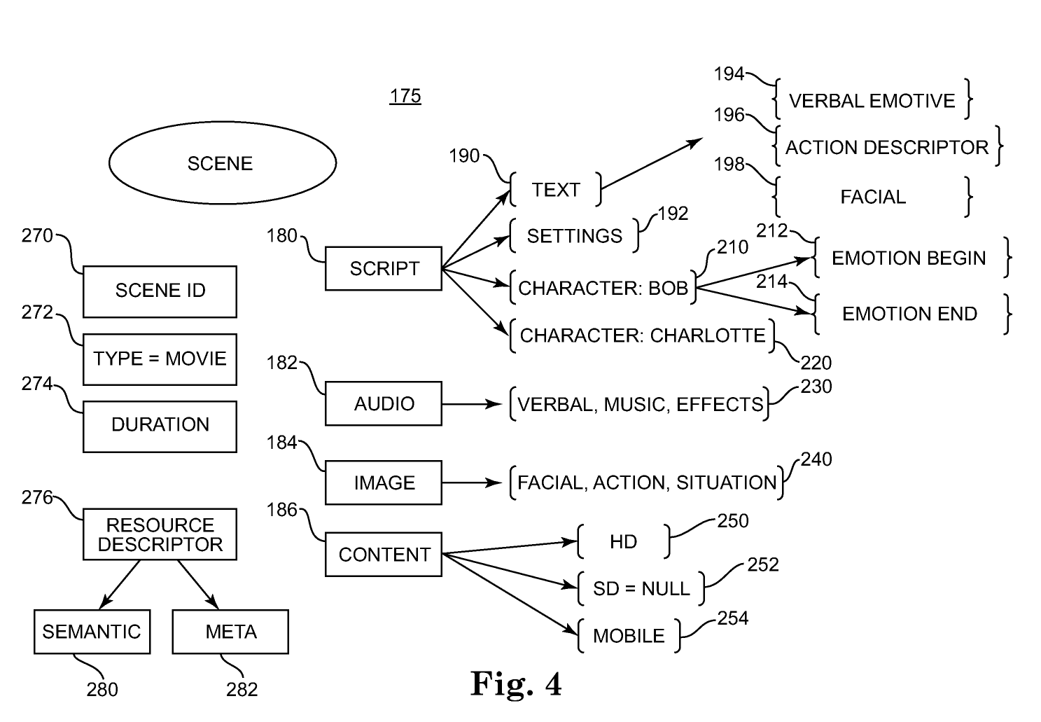

FIG. 4 is a diagram illustrating an index 175 of one scene of a program, according to one embodiment of the present disclosure. In one embodiment, scene index 175 includes a set of parameters that characterize and define a scene to distinguish one scene from another and to enable identifying one or more scenes that would be attractive to a user. As illustrated in FIG. 4, scene index 175 is defined by one or more of a script parameter 180, an audio parameter 182, an image parameter 184, a content parameter 186, a scene ID 270, a type parameter 272, a duration parameter 274, and a resource descriptor 276. These parameters 180-186 and 270-276 represent performance of a function and/or storage of information gathered by a particular function.

In one embodiment, script parameter 180 enables identifying elements and portions of a screenplay of the program that uniquely identify a scene. In one aspect, script parameter 180 includes text parameter 190, settings parameter 192 (e.g., a location of the character), and one or more character parameters 210, 220. The text 190 provides the narrative of the program including words that describe action (e.g. running) to be portrayed by the actor (represented by action descriptor 196), words (e.g., crying) that describe a facial expression (e.g., sad) of the character (represented by facial descriptor 198). A verbal emotive descriptor 194 of text parameter 190 includes verbal speech expressed in words or utterances spoken by a character that reveals their emotion. In one non-limiting example, verbal emotive descriptor 194 would denote anger as an emotion when the character's spoken words includes words such as “I hate you.”

The character parameters 210, 220 also include identifying a beginning emotion parameter 212 and an ending emotion parameter 214. If the emotion remains the same throughout a scene, then parameters 212, 214 represent a beginning intensity and an ending intensity, respectively, of one emotion. In either case, parameters 212, 214 are configured to indicate a relative change of emotion within a scene. As noted in connection with FIG. 2, in some instances a scene includes no change in emotion when the scene is differentiated as a separate scene for other reasons, such as a physical transition.

Audio parameter 182 of scene index 175 enables identifying elements (represented by a set 230 of verbal, music, and special effects) of an audio soundtrack of the program that uniquely identify an emotion of a scene. For example, the audio parameter 182 identifies sounds associated with various emotions, such as crying to reveal sadness, laughter to reveal happiness, yelling to reveal anger, etc. Moreover, audio parameter 182 identifies music (e.g., scary music) for association with fear of a character or special effects (e.g., birds chirping) for association with happiness.

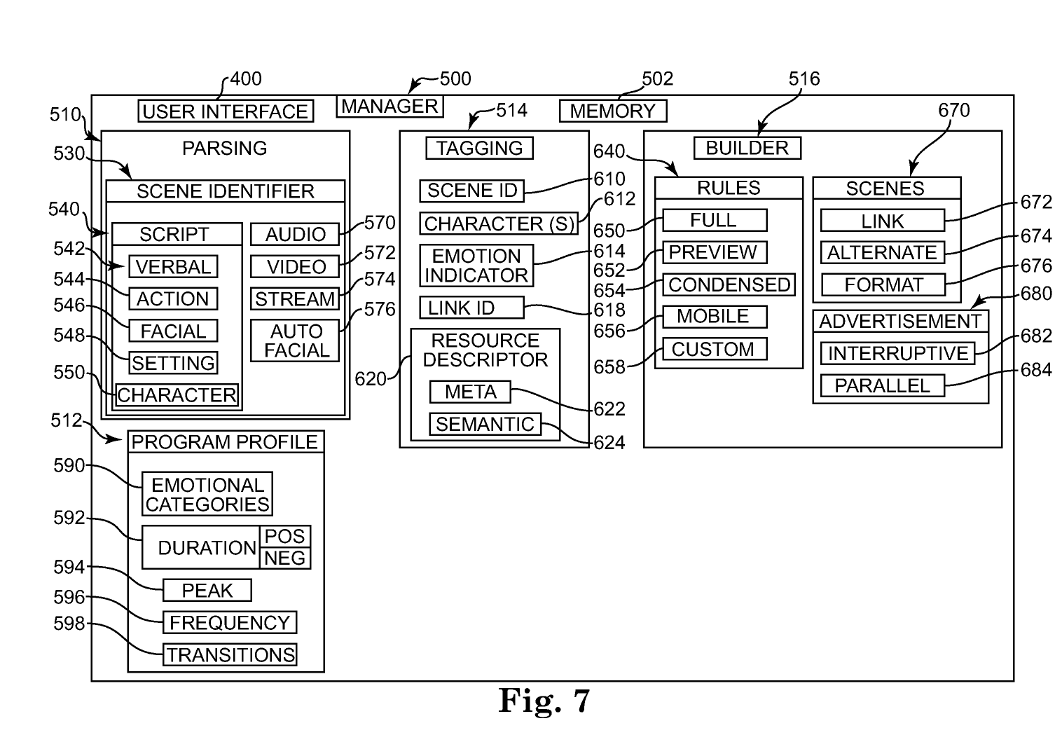

Image parameter 184 of scene index 175 enables identifying visual elements of the program that are observable in images of the media and that reveal an emotion of the character. These visual elements (represented by numeral 240) include a facial expression (e.g., smile), an action taken by the character (e.g., dancing), or an overall situation. Accordingly, by viewing the relevant images one can discern the emotion of the character. In another aspect, as described further in association with FIG. 7, techniques for automatically recognizing facial expressions are used to identify the visual elements to assist in differentiating one scene from another.

Content parameter 186 of scene index 175 enables tracking a format of a scene, such as whether the scene is recorded in standard definition (SD) format 252 or a high definition (HD) format 250. Content parameter 186 also includes modification parameter 254 which identifies whether the scene is suitable for inclusion in one of several modified versions of the program (e.g., mobile, condensed, etc.), as further described in association with FIG. 7. In one embodiment, modification parameter 254 additionally identifies whether a particular scene is a core scene to be included in full, condensed, or mobile versions of the program. In this regard, non-core scenes are excluded from the modified version of the program. In this embodiment, the method retains core scenes (and omits non-core scenes) of the program to maintain a baseline emotional pattern of a program despite the program having a shortened length.

Scene ID 270 of scene index 175 identifies an alphanumeric identifier of a scene (e.g., 73^{rd} scene of 120 scenes) within a sequence of scenes to uniquely identify a scene. Type parameter 272 of scene index 175 identifies a type of program (e.g., movie, event, TV show) to which the scene belongs. Duration parameter 274 identifies the duration of the scene and/or an elapsed time within the program at which the scene occurs. Resource descriptor 276 identifies a scene via a universal resource descriptor to enable access to the emotion-based scene index 175 via web searching or other networking resources. In one aspect, resource descriptor 276 includes a semantic web parameter 280 enabling the information of scene index 175 to be made available in a semantic web format. In another aspect, resource descriptor 276 includes a meta parameter enabling the information of scene index 175 to be made available in a meta data format or other web-based resource paradigm.

In one aspect, whether identified via script parameter 180, audio parameter 182, or image parameter 184, some non-limiting examples of a physical state of a character include a presence in a location, an absence from a location, a running state, a standing state, a sitting state, a walking state, an eating state, a talking state, a silent state, a sleeping state, etc.

FIG. 5 is a block diagram illustrating a system for characterizing and/or recommending a movie, according to one embodiment of the present disclosure. As illustrated in FIG. 5, system 350 includes a user 352, a manager 356, a programs resource 358, a content producer 360, a physical distribution resource 380, and a network communication link 385. In one aspect, the programs resource 358 includes a single source 362 and a distributed network source 366, which corresponds to a universe 370 of programs 372.

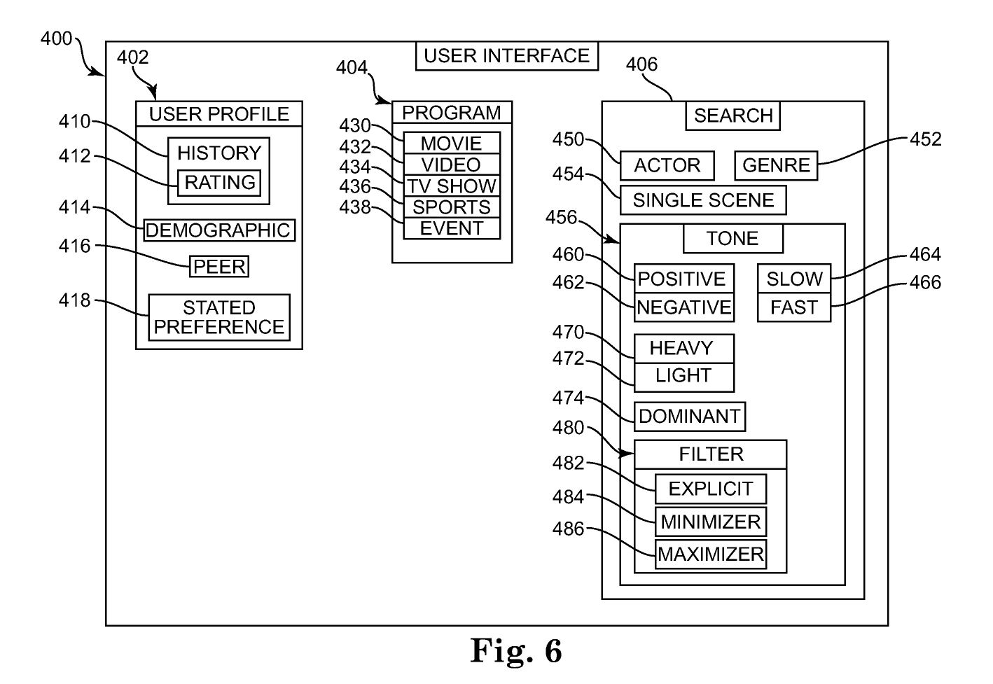

Manager 356 is configured to characterize programs to produce an emotional profile of each program and to make recommendations to the user 352 based on the emotional profiles of the respective programs. Manager 356 also is described further in association with at least FIGS. 6-7.

Programs resource 358 comprises a plurality of programs available to a user 352 via network communication link 385. The programs comprise any one or more of full length feature movies, videos, TV shows, sports events, other events. The programs 358 are provided by one or more single source providers 362 (e.g., an online retail movie provider) for rent or purchase. Alternatively, the programs 358 are made available through a variety of sources in a distributed network 366 across the World Wide Web or other electronic networks. Accordingly, the distributed network 366 provides a universe 370 of programs 372. In one aspect, the distributed network 366 includes a peer-to-peer storage network in which the programs and/or portions of the program(s) are stored in different nodes of a peer-to-peer network.

Content producer 360 creates, produces, and distributes programs to retail providers (e.g., single source provider 362 or distributed network 366) available via network communication link 385. Alternatively, content producer distributes its programs via a physical distribution resource 380, such as bricks-and-mortar stores, mail delivery, etc. In one aspect, content producer 360 makes an electronic version or physical copy of each program available for characterization by manager 356 so that the program is available for recommendation to a user whether or not the program is accessible via network communication link 385. Moreover, in some instances, content producer 360 cooperates with manager 356 to characterize a program as the program is being made, rather than having manager 356 characterize a program after it is produced. In addition, when a modified version of a program is produced via content producer 360, that modified program is deliverable via physical distribution resource 380.

FIG. 6 is a block diagram of a user interface 400 of a program characterization and recommendation system, according to one embodiment of the present disclosure. As illustrated in FIG. 6, user interface 400 includes user profile 402, program module 404, and search module 406. In one embodiment, user profile 402 of user interface 400 comprises substantially the same features and attributes of user profile 401 previously described in association with FIG. 1, as well as additional features described in association with FIGS. 6-7. For example, as illustrated in FIG. 6, viewing history parameter 410 of user profile 402 includes a rating mechanism 412 to enable the user to provide a rating of a viewed program. These ratings made by the viewer assist the manager 356 in identifying and recommending programs with emotional profiles comparable with positively rated programs while identifying and excluding programs having emotional profiles corresponding to negatively rated programs.

In other respects, viewing history parameter 410, demographic parameter 414, peer parameter 416, and stated preference parameter 418 have substantially the same features and attributes of the corresponding parameters 70-76 of user profile 40 of FIG. 1.

Program module 404 of user interface 400 enables selecting a type of programs that a user would like to view. In one embodiment, the program comprises any one or more of a movie 430, a video 432, a TV show 434, a sports program 436, and an event 438. However, this listing is not an exhaustive listing of all the type of programs suitable for characterization or recommendation via a method according to principles of the present disclosure.

The search module 406 enables a user to specify preferences of a program they would like to obtain and view. In one aspect, these preferences are stored in stated preference parameter 418 of user profile 402.

In one embodiment, search module 406 comprises an actor parameter 450, a genre parameter 452, a single scene parameter 454, and a tone module 456. The actor parameter 450 enables specifying the name of one or more actors and actresses that play characters in a movie. In aspect, the actor parameter 450 is used to specify the name of a character in a program, as many people are familiar with the name of a character as well as the name of actor or actress.

The genre parameter 452 enables a user to specify a genre (e.g., action, science fiction, etc.) to aid in searching. However, this genre parameter 452 is sometimes not employed if it is believed that it would interfere with the scene-based emotional profile matching performed according to principles of the present disclosure.

The single scene parameter 454 enables a user to specify the nature of a single scene, such as “nervous breakdown” or “sacrificial death”, to find programs with that type of scene. Moreover, in one embodiment, the single scene parameter 454 is employed in concert with the actor parameter to identify programs including a particular type of scene and a particular actor or actress.

The tone module 456 facilitates specifying a preference in the tone of a program. In one embodiment, the tone module 456 comprises a positive tone parameter 460, a negative tone parameter 462, a slow tone parameter 464, and a fast tone parameter 466. The positive tone parameter 460 enables a user to specify a preference, non-preference, or dislike for programs having a positive tone (e.g., happy, victory, loving) while negative tone parameter 462 enables a user to specify a preference, non-preference, or dislike for programs having a negative tone (e.g., anger, sadness, hate). Similarly, the slow parameter 464 enables a user to specify a preference, non-preference, or dislike for programs having a slow pace (e.g., nature documentary) while fast parameter 466 enables a user to specify a preference, non-preference, or dislike for programs having a fast pace (e.g., action thriller).

In addition, in some embodiments, tone module 456 comprises a heavy parameter 470, a light parameter 472, and a dominant emotion parameter 474. The heavy parameter 470 enables specifying a preference, non-preference, or dislike for programs with a heavy subject matter or a heavy feel (e.g., holocaust) while the light parameter 472 enables specifying a preference, non-preference, or dislike for programs with a light subject matter or a light feel (e.g., gardening). In one embodiment, the dominant emotion parameter 476 is configured to specify a dominant emotion (e.g., sadness, happiness, anger, etc.) of a program, if such a dominant emotion is present in the program.

In one embodiment, the tone module 456 further includes a filter module 480 comprising an explicit parameter 482, a minimizer parameter 484, and a maximizer parameter 486. The filter module 480 enables a user to select a program or request a recommendation of a program with the additional provision that the program be edited or filtered to remove certain types of scenes. In one embodiment, the explicit parameter 482 of filter module 480 acts to filter out programs including explicit subject matter (e.g., images or audio) so that they are excluded from the universe of programs to be recommended. Alternatively, the explicit parameter 482 enables specifying that any programs including explicit subject matter by automatically edited for removal of explicit scenes.

The minimizer parameter 484 of filter module 480 enables specifying a preference that high intensity emotions of a recommended program be minimized by excluding those high intensity emotional scenes. The maximizer parameter 486 of filter module 480 enables specifying a preference for programs including high intensity emotional scenes.

FIG. 7 is a block diagram of a manager 500, according to one embodiment of the present disclosure. In one embodiment, the manager 500 comprises at least substantially the same features and attributes as manager 356 of system 350 of FIG. 5. In another embodiment, manager 356 (FIG. 5) comprises at least substantially the same features and attributes as manager 500 of FIG. 7.

In one embodiment, as illustrated in FIG. 7, manager 500 includes user interface 400 (FIG. 6), parsing module 510, program profile module 512, tagging module 514, and builder module 516.

The parsing module 510 of manager 500 is configured to analyze a program to define and differentiate scenes within the program. In particular, the parsing module 510 parses the program to identify each unique scene according to a display of an emotion by a character. In some instances, a physical transition within the program (e.g., a move to a new location for a character, or form one character to another) will define a scene.

In one embodiment, parsing module 510 comprises scene identifier function 530 including a script module 540, an audio identifier 570, an image identifier 572, a stream identifier 574, and an auto facial recognizer 576. In one aspect, scene identifier 530 uniquely identifies a scene within a program via an alphanumeric identifier, in accordance with the scene ID 270 of scene index 175 described in association with FIG. 4.

The script module 540 is configured to automatically evaluate aspects within a screenplay or textual script of a program that identify an emotion associated with a character. In one embodiment, the script module 540 comprises a verbal parameter 542, an action parameter 544, and a facial parameter 546. The verbal, action, and facial parameters 542, 544, 546 of script module 540 have substantially the same features and attributes as the verbal emotive, action, and facial descriptors 194, 196, 198 of text parameter 190 (respectively) of scene index 175 as previously described in association with FIG. 4. Accordingly, these verbal, action, and facial parameters 542, 544, 546 enable manager 500 to gather information regarding an emotion of character by analyzing the text of a screenplay.

The script module 540 also comprises a settings parameter 548, and a character parameter 550. The settings and character parameters 548, 550 of script module 540 have substantially the same feature and attributes as the settings and character parameters 192, 210, 220 of script parameter 180 of scene index 175 as previously described in association with FIG. 4. Accordingly, the settings parameter 548 enables identifying a scene by a physical location (e.g., an office, a garden,) of a character, while character parameter 550 enables identifying a scene by which, if any, characters are present within a particular scene. While a character is generally present within most scenes and displays an emotion within a scene, some scenes omit a character because the scene is used for a physical transition and/or to evoke an emotion in the viewer based on non-character thematic elements (e.g., showing an eagle fly, showing waves roll in to shore, showing city traffic, etc.).

In some embodiments, the scene identifier module 530 of parsing module 510 also comprises an audio identifier 570, an image identifier 572, a stream identifier 574, and an auto facial recognizer 576. The audio identifier 570 and image identifier 572 of scene identifier module 530 have substantially the same features and attributes as the audio function and the image function 182, 184, respectively, as previously described in association with FIG. 4.

The stream identifier 574 is configured to analyze a digital signal of the audio and video portions of a program to assist in differentiating scenes from each other. One example of a stream identifier is provided in Zhang, U.S. Patent Publication 2006/0230414, assigned to Hewlett Packard Company.

The auto facial recognizer 576 is configured to identify characters via automatic facial recognition, as known by those skilled in the art such as those reported in Face Recognition Vendor Tests (FRTV) 2006 and Iris Challenge Evaluation (ICE) 2006 Large-Scale Results, National Institute of Standards and Technology NISTIR 7408. In one aspect, the auto facial recognizer 576 complements the textual recognition (via character parameter 550) of a particular character or actor in identifying scenes including a particular character (or actor).

In one embodiment, scenes are characterized and differentiated via scene identifier 530 at the time that the program is first being produced. In this embodiment, the different scenes of the program are defined according to the emotion displayed by a character in a manner substantially the same as previously described in association with FIGS. 1-6, except that manager 500 will not have to differentiate the scenes at a later time. Instead, each scene is tagged prior to release of the program by the producer or distributor.

The program profile 512 of manager 500 is configured to produce a profile of one or more emotions of a character or characters in a program. One non-limiting example of an emotional profile produced via program profile is illustrated in FIG. 2, in which a profile 102f the relative happiness of one character is plotted over the sequence of scenes of the program. As previously described in association with FIG. 2, recognizable patterns in the graphically-represented emotional profile 102 are used for comparison with criteria or information in a user profile. This comparison determines whether a program matches the tastes and habits of a user, and therefore whether that program is recommended for viewing by the user.

In one embodiment, program profile 512 comprises an emotional categories function 590, a duration function 592, a peak function 594, a frequency function 596, and a transitions function 598. The emotional categories function 590 is configured to specify which emotion(s) of a character are to be tracked and plotted in a graphically-represented emotional profile. The duration function 592 enables specifying various parameters for which a duration of an emotional display will be tracked and/or recognized. For example, duration function 592 enables tracking the maximum duration (counted by time or number of scenes) of a negative or positive emotion of a character. The peak function 594 enables specifying various parameters for which a peak intensity of an emotion will be tracked and/or recognized. For example, peak function 594 enables recognizing and tracking the peak intensity of an emotion (positive or negative) of a character. The frequency function 596 enables tracking a frequency of changes between different emotions (e.g., happiness and confusion) or changes between positive and negative poles of a single emotion (e.g. happiness and unhappiness).

The transitions function 598 enables specifying and tracking the number of physical transitions within a program. For example, a fast paced action movie would have a large number of physical transitions and recognizing a pattern of a large number of physical transitions will assist manager 500 in recommending (or avoiding) programs with such a profile.

The tagging module 514 of manager 500 is configured to electronically mark or tag a scene and/or elements of a scene, thereby enabling automatically searching, grouping, access, or other handling of each scene of a program. In particular, electronically tagging each scene (and elements of a scene) facilitates building an emotional profile of a program as well as comparing the emotional profile (as a whole or on a scene-by-scene basis) with a user profile.

In one embodiment, as illustrated in FIG. 7, the tagging module 514 includes a scene ID 610, a character ID 612, an emotion indicator 614, a link ID 618, and a resource descriptor 620 with a meta parameter 622 and a semantic parameter 624. The scene ID 610 substantially corresponds to the scene ID 270 of scene index 175 of FIG. 4 that uniquely identifies a scene within a sequence of scenes of a program. The character ID 612 enables specifying the name or alphanumeric identifier of each character within a program, as well as the name or alphanumeric identifier of the actor or actress corresponding to a respective character. Accordingly, the character ID 612 substantially corresponds to the character parameters 210, 220 of scene index 175 of FIG. 4.

The emotion indicator 614 identifies an emotion (or change in emotion) of a character in a scene of the program, and substantially corresponds to the beginning emotion parameter 212 and ending emotion parameter 214 of a scene, as previously described in association with FIG. 4.

The link ID 618 is configured to assign a rule identifier (e.g. preview, mobile, full), in cooperation with rules module 640, to a scene so that at a later time, scenes with that respective rule identifier are collated or aggregated into an appropriate sequence to provide a desired version of the program. In one aspect, link ID 618 cooperates with modification parameter 254 to tag scenes for inclusion into a modified version of a program.

In another embodiment, link ID 618 and modification parameter 254 cooperate to enable building a compilation of scenes from different programs to act as a preview or other modified version of a program. For example, one could compile a greatest hits or anthology of scenes for an actor or character into one new program.

The resource description 620 is configured to provide the electronic tagging information of a scene and its elements in a universal resource descriptor format. This arrangement facilitates broad access to the information of the emotional profile of a program across a wide spectrum of computing infrastructure, such as the World Wide Web, the Semantic Web, or other network resource paradigms. In one embodiment, the resource descriptor 620 (including meta parameter 622 and semantic parameter 624) comprises substantially the same features and attributes as resource descriptor 276 of scene index 175 of FIG. 4 (including semantic parameter 280 and meta parameter 282).

The builder module 516 of manager 500 is configured to aggregate a plurality of scenes into a program according to one or more rules. Accordingly, the builder module 516 is used by manager 500 after a program has been apportioned into a sequence of scenes according to the principles of the present disclosure.

In one embodiment, the builder module 516 comprises a rules module 640, a scene selector module 670, and an advertisement module 680. The rules module 640 comprises full parameter 650, preview parameter 652, a condensed parameter 654, a mobile parameter 656, and a custom parameter 658. The full parameter 650 is configured to maintain all the scenes of the program that correspond to a full length of the program.

The preview parameter 652 is configured to specify that a limited number of the scenes of a program be aggregated into a preview version of the program. Accordingly, upon all the scenes within a program being identified and indexed, one can specify the preview parameter 652 to automatically build a preview version of a program. The preview parameter 652 collates all scenes that are tagged (via link ID 618 and modification parameter 254 of content function 186) as preview scenes and aggregates them together in a desired sequence to form a preview.

In another aspect, condensed parameter 654 collates all scenes indexed or tagged (via link ID 618 and modification parameter 254) as being a condensed-type scene and aggregates them together in the proper sequence (i.e., according to an event timeline of the plot) to form a condensed version of the program. A substantially similar arrangement is provided for mobile parameter 656 in which all scenes tagged or indexed as mobile-type scenes are collated into a mobile version of the program. The custom parameter 658 enables a producer to select whichever scenes they choose for inclusion into a rule to define a sequence of scenes as a custom program.

The scene selector module 670 of builder module 516 is configured to enable selecting certain scenes to achieve a modified version of a program. In one embodiment, the scene selector module 670 comprises link parameter 672, alternate parameter 674, and format parameter 676. The alternate parameter 674 is configured to tag or index certain scenes that act as alternate scenes when one or more scenes are excluded from a rule (i.e., modified program) because of the subject matter of the excluded scene or for other reasons. The format parameter 676 is configured to specify the format of a particular scene, such as whether the scene is in standard definition or high definition. Accordingly, the format parameter 676 enables automatic or manual selection of the high definition parameter 250 or standard definition parameter 252 of scene index 175 (see FIG. 4) for a particular scene.

The advertisement module 680 is configured to insert advertisements into a program via an interruptive function 682 or a parallel function 684. The interruptive function 682 places an advertisement between otherwise consecutive scenes of the program while the parallel function 684 displays advertisements in parallel with one or more scenes. In other words, in the parallel function 684, the advertisement is displayed simultaneously with one or more scenes in the form of a caption, picture-in-picture, subtitle or other mechanism.

In one embodiment, memory 502 represents the storage of manager 500 in a memory within a web site or other network accessible resource.

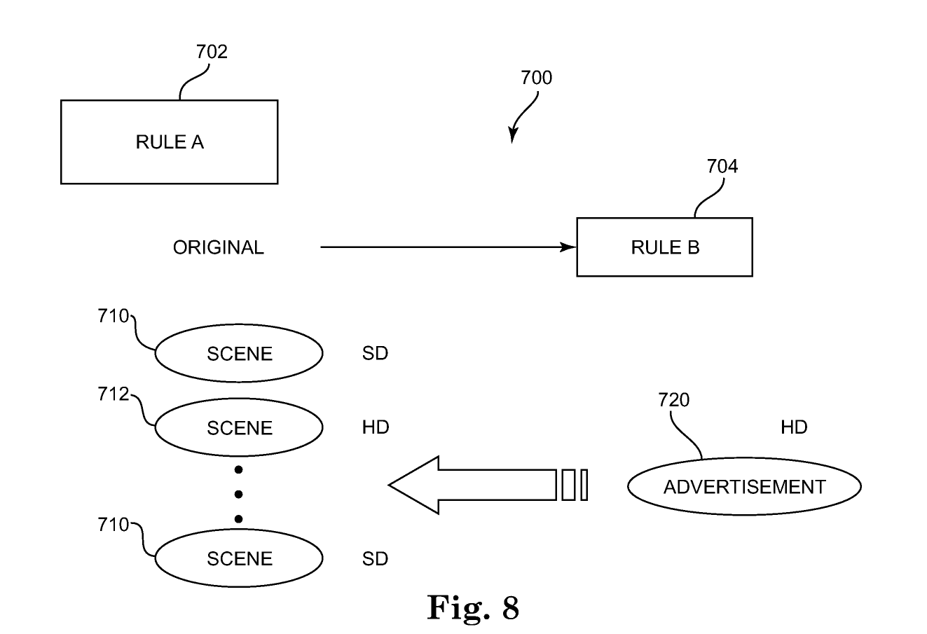

FIG. 8 is a diagram 700 illustrating conversion of a first rule 702 (represented as Rule A) set of scenes to a second rule 704 (i.e., Rule B) set of scenes upon inserting an advertisement 720, via advertisement module 680 in FIG. 7, into a series of scenes. In one aspect, diagram 700 also illustrates the interruptive parameter 682 of FIG. 7 because the advertisement 720 is inserted between two otherwise consecutive scenes 710, thereby interrupting the sequence of the scenes. In another aspect, diagram 700 illustrates the application of format parameter 676 of scene selector module 670 by insertion of a high definition scene 712 just prior to a high definition advertisement 720. With this arrangement, a user would better appreciate the smoother flow from a high definition scene to high definition advertisement.

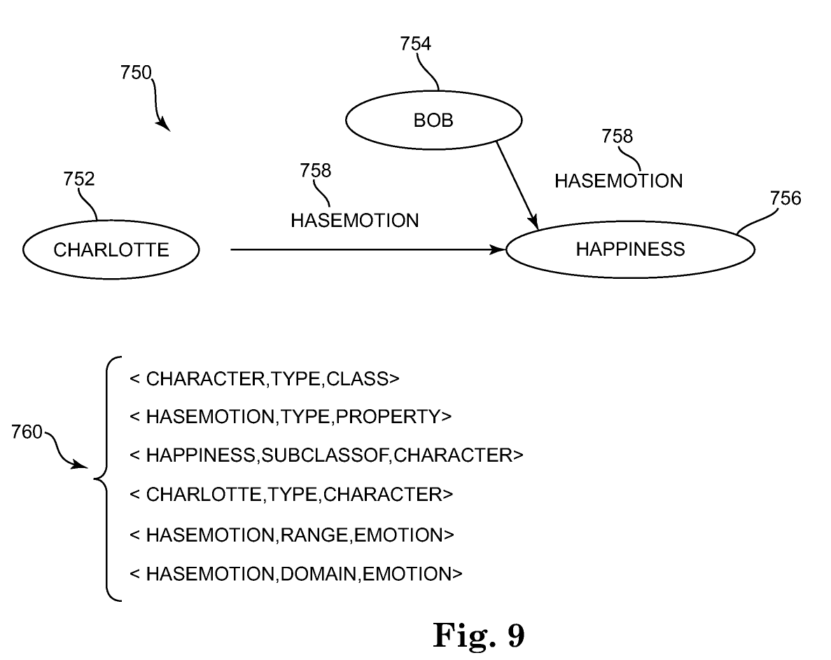

FIG. 9 is a diagram 750 of elements of a scene represented in a resource descriptor scheme, according to one embodiment of the present disclosure. As illustrated in FIG. 9, the elements of the scene include a first character 752 (i.e., Charlotte), second character 754 (i.e., Bob), and an emotion 756 (i.e., happiness). In addition, the emotion 756 is represented as a type of the Property. Finally, diagram 750 demonstrates a set 760 of resource descriptor definitions, in the RDFS framework, for the character Charlotte and for the emotion Happiness. By using such universal resource descriptors to index elements of a scene, these universal resource descriptors are available to build rule sets as well as make the tagged or indexed scenes searchable throughout a distributed communication network. In another aspect, use of such universal resource descriptors enables indexing each scene to apportion the various scenes of a program as well to facilitate re-building the scenes into the original program or a modified program.

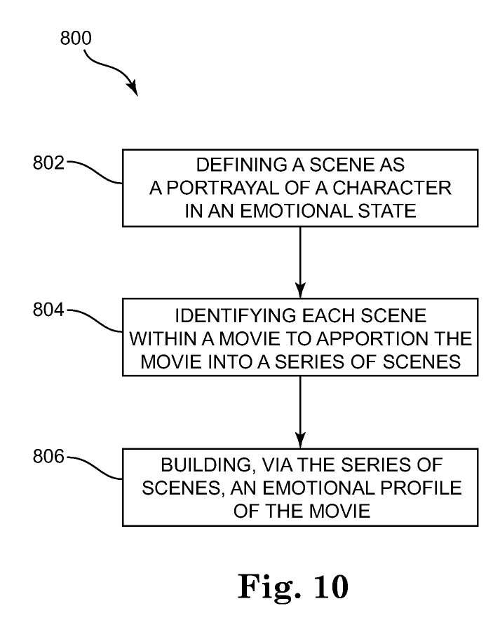

FIG. 10 is a flow diagram of a method 800 of characterizing a program, according to one embodiment of the present disclosure. In one embodiment, method 800 is performed using any one of the system and methods previously described in association with FIGS. 1-9. In other embodiments, systems and methods other than those described in association with FIGS. 1-9 are used to perform method 800.

As illustrated in FIG. 10, at block 802 method 800 comprises defining a scene as a portrayal of a character displaying an emotion or having an emotional state (e.g., happy, sad, etc.). At block 804, each scene is identified within a movie (or other program) to apportion the program into a series of scenes. Next, method 800 includes building, via the series of scenes, an emotional profile of the program. As previously described, in some embodiments this characterization of the program via a scene-based emotional profile in further used to recommend one or more such programs upon comparison of the respective emotional profiles with a user preference profile.

Embodiments of the present disclosure enable accurate characterization and/or recommendation of a program. Accordingly, users gain greater access to the extensive and diverse universe of programs available as digital content, as well as available in more traditional formats. Likewise, owners of more obscure or less publicized digital content now have the opportunity to become more visible to users, distributors, producers, etc. Finally, in addition to the generally greater access afforded to the user, the user will enjoy more programs because of the accuracy in identifying programs suited to their preferences.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of characterizing a program comprising:
defining a scene as a portrayal of an emotion of a first character;
identifying each scene within a first program to apportion the first program into a series of scenes; and
building, via the series of scenes, an emotional profile of the first program.

2. The method of claim 2, comprising:
providing an emotional preference profile of a first user;
providing an array of programs, including the first program, wherein each respective program includes a scene-based emotional profile; and
recommending one or more of the respective emotionally-profiled programs to the user based on a correlation between the emotional profile of the respective programs and the emotional preference profile of the first user.

3. The method of claim 2, further comprising:
supplying access to the recommended respective programs via at least one of a network communication link or a physical distribution resource.

4. The method of claim 2, comprising:
further defining each scene as the portrayal of the first character experiencing a change from one emotion to another emotion.

5. The method of claim 4 wherein the emotion of the first character in one of the respective scenes comprises at least one of happiness, sadness, anger, surprise, fear, or contempt.

6. The method of claim 4 wherein building the emotional profile comprises:
identifying, via the series of scenes, at least one of a maximum intensity of each respective emotion, a frequency of transitions between the respective emotions, a maximum change between two respective emotions, or a maximum duration of each of the respective emotions.

7. The method of claim 4 wherein providing the emotional preference profile of the first user comprises:
obtaining from the first user an indication of a preference, a non-preference, or a dislike for each of the respective emotions of the first character.

8. The method of claim 1 wherein defining the event further comprises:
additionally defining the event as a physical parameter of the first character, wherein the physical parameter includes a presence, an absence, or a physical state, of the first character.

9. The method of claim 8, comprising:
further defining the physical state as a transition from one physical situation to another physical situation.

10. The method of claim 9 wherein the physical state of the first character includes at least one of a presence in a location, a running state, a standing state, a sitting state, a walking state, an eating state, a talking state, a silent state, or a sleeping state.

11. The method of claim 1, wherein the first character comprises a protagonist of the program, further comprising:
further defining at least some of the respective scenes as including a second character and defining the event of the respective scenes as the second character displaying one of the emotions.

12. The method of claim 1, wherein identifying each scene comprises at least one of:
identifying text within a script of the program that represents the emotion of the first character in each respective scene;
identifying an elapsed time within the program at which the respective scene occurs;
identifying an identity of the first character; and
identifying the emotion of the first character at a beginning of the scene and the emotion of the first character at an end of the scene.

13. The method of claim 1, wherein identifying each scene comprises at least one of:
assigning a unique alphanumeric scene identifier to each respective scene; or
identifying a format type including at least one of a high definition format or a standard definition format.

14. The method of claim 1, further comprising:
building a preview of the program via selecting scenes including the first character and also including one emotion of a plurality of different emotions.

15. The method of claim 1, further comprising:
electronically tagging a subset of the scenes, wherein each tagged scene corresponds to a core scene of the program; and
building a condensed version of the program via aggregating the core scenes into a sequence that substantially maintains a baseline emotional pattern of the program.

16. The method of claim 1, comprising:
setting a maximum emotional intensity within the user preference profile; and
building a modified version of the program that is limited to scenes that include emotions of the first character less than the maximum emotional intensity.

17. The method of claim 1, further comprising:
storing the scenes in a database;
rebuilding the program via aggregating the scenes into a sequence corresponding to an event timeline of a plot of the program; and
adding an advertisement to the program via at least one of inserting the advertisement between consecutive scenes of the program or displaying the advertisement simultaneously during display of one or more of the respective scenes.

18. A system for selecting a program, the system comprising:
a preference module configured to build a user emotional preference profile;
a universe of programs with each program stored as an emotionally-indexed series of scenes; and
a recommendation module configured to automatically select one of the respective cataloged programs based on a comparison of the user emotional preference profile to the scene-based emotional index of each respective cataloged program.

19. The system of claim 18, comprising:
an emotional indication module configured to identify each respective scene as including one emotional indicator associated with a character of the program; and
electronically marking each identified respective scene with at least one of a meta-data tag, a semantic web tag, or a scene content universal resource identifier.

20. The system of claim 19 wherein the emotion indicators comprise at least one of:
an emotion-related text of a screen play of the program;
a verbal utterance of the first character in the program;
at least one of at least six different emotional facial expressions; or
an emotion-invoking portion of a soundtrack associated with the movie.

21. The system of claim 18 wherein the user preference profile comprises at least one of a viewing history parameter, a demographic parameter, or a peer parameter.

22. A video characterization system comprising:
means for identifying a segment within a video that includes an emotion-invoking event associated with a character;
means for parsing the video to apportion the video into a series of segments;
means for tagging each segment with an emotional indicator to indicate a type of emotion and an intensity of the emotion associated with the emotion-invoking event; and
means for building, via the series of segments, an emotional profile of the video.

23. The video characterization system of claim 22 wherein the video comprises at least one of:
a video recording of a sports event, wherein the emotion-invoking event of one of the respective segments comprises a sports play that includes the character; or
a TV show, wherein the emotion-invoking event of one of the respective segments comprises a scene in the TV show that includes the character.

24. The video characterization system of claim 22 wherein the means for tagging comprises a semantic web resource manager configured to represent the emotional indicator of one of the respective segments in a semantic web schema.
